(19) United States
(12) Patent Application Publication
(10) Pub. No.: US 2026/0318276 A1
(43) Pub. Date: Oct. 15, 2026

(54) LOW TIDAL FLOW SUBMERSIBLE POWER PLANT

(71) Applicant: Minesto AB, Göteborg (SE)

(72) Inventor: Björn Bergqvist, Göteborg (SE)

(21) Appl. No.: 19/484,468

(22) PCT Filed: Jun. 2, 2023
(86) PCT No.: PCT/SE2023/050546

§ 371 Date: Nov. 14, 2025

(51) Int. Cl. F03B 13/26; F03B 15/04

(52) U.S. Cl. CPC F03B 13/264; F03B 15/04; F05B 2240/311; F05B 2240/374; F05B 2240/917

(57) ABSTRACT

A submersible power plant comprises a major rotor arranged on a buoyant body relative which it can rotate. The major rotor comprises at least two major rotor blades and is rotatable around a major rotor axis from a fluid flow acting on the major rotor blades. The major rotor comprises a minor rotor arranged on each major rotor blade, each comprising a minor rotor blade rotatable around a minor rotor axis substantially perpendicular to the major rotor axis and to an extension of the major rotor blades from the major rotor axis to each major rotor blade end. The buoyant body of the submersible power plant is arranged to be secured to a structure by means of a tether and is arranged to change the angle of the major rotor axis relative the direction of the fluid flow, controlling the rotational speed of the major rotor.

### TECHNICAL FIELD

The invention relates to a submersible power plant comprising a major rotor arranged on a buoyant body around which the major rotor can rotate, wherein the major rotor comprises at least two major rotor blades and is rotatable around a major rotor axis from a fluid flow acting on the major rotor blade.

### BACKGROUND ART

Today, various technologies exist for converting the kinetic energy in tidal or ocean streams into electrical energy by means of submersible power plants.

In order to convert the movement of low velocity tidal streams, a large swept area is needed or the swept area is poorly utilized that leads to very sparse grid arrangements. Today's solutions also does not provide a sufficient energy output on large depths. Today's solutions for providing power plants with a large swept area often includes stationary rotors that are costly to install and maintain.

There is thus a need for an improvement within the field of submersible power plants.

### SUMMARY OF THE INVENTION

One object of the present invention is to provide a submersible power plant where the previously mentioned problems are at least partly avoided. This object is achieved by the features of the characterising portion of claim 1. Variations of the invention are described in the appended dependent claims.

The invention relates to a submersible power plant comprising a major rotor arranged on a buoyant body around which the major rotor can rotate. The major rotor comprises at least two major rotor blades and is rotatable around a major rotor axis from a fluid flow acting on the major rotor. The major rotor comprises a minor rotor connected to a minor generator arranged on each major rotor blade, wherein each minor rotor have a minor rotor blade rotatable around a minor rotor axis from the rotation of the major rotor. Each minor rotor axis is substantially perpendicular to the major rotor axis and to an extension of the major rotor blades from the major rotor axis to each major rotor blade end. The buoyant body of the submersible power plant is arranged to be secured to a structure by means of a tether. The submersible power plant is arranged to change the angle of the major rotor axis relative the direction of the fluid flow, thereby controlling the rotational speed of the major rotor.

One advantage with a submersible power plant according to the disclosure is that such a power plant makes it possible to extract more energy from the swept area of the power plant, thereby allowing for higher grid packaging. Compared to previous solutions where the power plant is stationary which may prevent installation at certain depths, the system motion of the submersible power plant according to the disclosure allows it to be easily adaptable for different depths in order to extract as much flow as possible from a specific flow at a specific location, regardless of the depth of maximum flow velocity. Such a power plant will also make possible dense grid arrangements. As the movement of the submersible power plant is constrained, it allow for less spacing between each power plant. Also, the swept area of each power plant can be increased without having to handle the enormous torque in the middle of the large turbine as the power plant and thereby major rotor does not move significantly during operation. A power plant according to the disclosure also requires less maintenance than today's power plants.

A submersible power plant according to the disclosure allows for a low cut in velocity, leading to that the major rotor of the submersible power plant will start to rotate at low flow speeds compared to previous solutions.

The submersible power plant according to the invention provides a less complex solution that paves the way for the big systems needed to extract energy from slow flows. A less advanced control system is needed compared to a submersible power plant that moves cross the fluid flow direction.

The submersible power plant may comprise an arm connected to the tether and the buoyant body, wherein the arm is rotatably connected to the buoyant body and is arranged to change the angle of the major rotor axis relative the direction of the fluid flow by rotating the arm relative the buoyant body. By installing an arm between the tether and the buoyant body that is rotatably connected to the buoyant body, by changing the angle of the rotatable attachment of the arm relative the buoyant body, the angle of the major rotor axis relative the direction of the fluid flow is changed.

The arm may be buoyant. By providing the arm with buoyancy, the centre of buoyancy of the entire submersible power plant can be adjusted.

The major rotor blades may be flexible. In this way, the rotor blades can bend at high flow, thereby altering the centre of buoyancy of the submersible power plant. This changes the angle of the major rotor axis relative the direction of the fluid flow and reduces the rate of rotation of the major rotor.

The span and thickness of the major rotor blade may decrease towards an end of the major rotor blade. This allows for a better structural integrity of the submersible power plant.

The major rotor blades may comprise control surfaces. Control surfaces on the major rotor such as for instance flaps or ailerons, can change the angle of the major rotor axis relative the direction of the fluid flow and reduce or increase the rate of rotation of the major rotor.

The control surfaces of each major rotor blade may be individually controllable. In this way, an increased control of the angle of the major rotor axis relative the direction of the fluid flow can be achieved.

The buoyant body may comprise at least one ballast tank. By filling and emptying a ballast tank, the angle of the major rotor axis relative the direction of the fluid flow can be changed.

The minor rotors can be run in reverse to control the rotational speed of the major rotor. To further assist in controlling the rotational speed of the major rotor, the minor rotors can be used as motors to reduce the rotational speed of the major rotor. The opposite is of course also possible, i.e. to use the minor rotors to increase the rotational speed of the major rotor. This can be useful during start-up of operation of the submersible power plant.

The angle of the major rotor axis relative the direction of the fluid flow can be changed such that the rotational speed of the major rotor is essentially zero. In this way, the submersible power plant can be moved to the surface for maintenance. When the rotational speed of the major rotor is essentially zero, the submersible power plant can be set in a state suitable for slack tide.

The major rotor may comprise stop flaps. This helps in achieving and maintaining a rotational speed of the major rotor of essentially zero at low to normal flow speeds.

The buoyant body may comprise a motor arranged to untwist the tether by rotating the buoyant body relative the major rotor when the rotational speed of the major rotor is essentially zero. When the major rotor is not spinning, it is possible to rotate the buoyant body relative the major rotor by means of a motor to untwist the tether if necessary. Alternatively, the minor turbines can be used as motors to untwist the tether.

The buoyant body may comprise power electronics. The buoyant body could also contain electrical equipment needed for operation of the submersible power plant leading to that this equipment does not have to be put onshore. Since the output of the submersible power plant is not affected by the size of the centrepiece, only the swept area of the major rotor, it is possible to put inverters, transformers and more in it. This makes the onshore part of the installation minimal and more cost effective.

The tether may be divided into two parts, each arranged to be removably connected to a structure. A double tether attachment enables the submersible power plant to get to the surface while still being attached. Connecting the submersible power plant with a two-part tether decreases the buoyancy need of the submersible power plant.

The major rotor may be mechanically connected to a major generator inside the buoyant body such that electrical power is generated by the rotation of the major generator by the major rotor.

This provides an additional source of electric power that can be generated by the power plant.

The tether may comprise electrical cables and signal cables for routing electrical power generated by the generators to an onshore substation.

This allows the electric power to be transferred from the submersible power plant to shore for further distribution.

### BRIEF DESCRIPTION OF THE DRAWINGS

FIG. 1 schematically shows a perspective view of a submersible power plant according to the invention,

FIGS. 2a-2e shows the submersible plant with different angles of the major rotor axis relative the direction of the fluid flow, 1

FIG. 3 schematically shows a cross sectional view of the buoyant body of the submersible power plant of the invention,

FIGS. 4a and 4b schematically show a two part tether anchoring according to an example embodiment of the invention.

### DETAILED DESCRIPTION

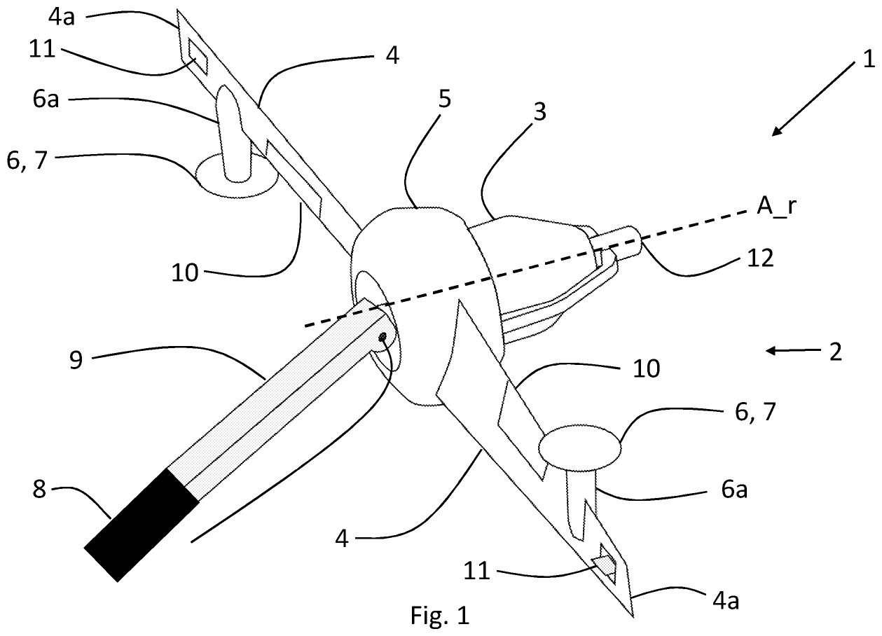

FIG. 1 schematically shows a perspective view of a submersible power plant 1 according to the invention. The submersible power plant 1 comprises a major rotor 2 arranged on a buoyant body 3 relative which the major rotor 2 can rotate. The major rotor 2 comprises at least two major rotor blades 4 extending radially outwards from a rotor hub 5 that is rotatably arranged on the buoyant body 3. The rotor hub 5 may be buoyant. The major rotor 2 is rotatable around a major rotor axis A_r from a fluid flow acting on the major rotor blades 4. The major rotor axis A_r run through the centre of the buoyant body 3 in an axial direction relative the major rotor 2.

The major rotor 2 comprises a minor rotor 6 arranged on each major rotor blade 4. Each minor rotor 6 comprises a minor rotor blade 7 rotatable around a minor rotor axis. Each minor rotor axis is substantially perpendicular to the major rotor axis A_r and to a radial extension of the major rotor blades 4 from the major rotor axis A_r to each major rotor blade end 4a. Each minor rotor 6 is mechanically connected to a minor generator 6a arranged on each major rotor blade 4. The minor rotors 6 travel through the fluid by the rotation of the major rotor 2 and the flow thereby acting on the minor rotors 6 cause them to rotate. This in turn causes the minor generators 6a to rotate and generate electric power. The electric power generated by the minor generators are transferred to the buoyant body 3 by means of power cables inside the major rotor blades 4. The buoyant body 3 further comprises power electronics (not shown) to route the electrical power generated by the minor generators 6a to shore.

In one alternative embodiment, the major rotor 2 is mechanically connected to a major generator (not shown) inside the buoyant body 3 such that electrical power is generated not only by the rotation of the minor generators 6a by the rotation of the minor rotors 6 when the major rotor 2 rotates but also from rotation of the major generator. This can be used in applications when auxiliary or additional power is sometimes required.

The buoyant body 3 of the submersible power plant 1 is arranged to be secured to a structure (not shown) on the seafloor or on the surface by means of a tether 8. The tether 8 comprises a load-bearing portion for securing the submersible power plant 1 to the structure and ensuring that the loads exerted on the submersible power plant 1 can be handled. The tether 8 further supports the required electrical and signal cables required for routing the electrical power generated by the minor and, if used, major generators to an onshore substation for further distribution to an electric consumer, such as an electric grid, a factory, a residential area or similar.

In order to control various operational scenarios, the submersible power plant 1 is arranged to change the angle of the major rotor axis A_r relative the direction of the fluid flow F_d, thereby controlling the rotational speed of the major rotor 2.

In one example of a way to change the angle of the major rotor axis A_r relative the direction of the fluid flow F_d, the submersible power plant 1 comprises an arm 9 rotatably connected to the buoyant body 3 and to the tether 8. During operation of the power plant 1, the buoyant body 3, the tether 8 and the arm 9 does not rotate relative the major rotor 2. The arm 9 is arranged to change the angle of the major rotor axis A_r relative the direction of the fluid flow F_d by rotating the arm 9 relative the buoyant body 3. This can be achieved by for instance an electric motor rotating the connection between the arm 9 and the buoyant body 3 or by an electrical actuator connected to the arm 9 and to the buoyant body 3 that moves the arm 9 relative the buoyant body 3. In one example embodiment, the arm 9 is buoyant. The buoyancy of the arm 9 can be adapted such that the arm 9 will rotate relative the buoyant body 3 when the fluid flow F_d changes and thereby changing the angle of the major rotor axis A_r relative the direction of the fluid flow F_d. Alternatively, the arm 9 can be connected to the buoyant body 3 by a spring with a spring constant adapted to allow the arm 9 to rotate relative the buoyant body 3 when the fluid flow F_d changes and thereby changing the angle of the major rotor axis A_r relative the direction of the fluid flow F_d.

As an alternatively or complementary way to change the angle of the major rotor axis A_r relative the direction of the fluid flow F_d, the major rotor blades 4 are flexible. At high flow velocities, the major rotor blades 4 may bend, thereby altering the center of buoyancy of the submersible power plant 1 and the rotational speed of the major rotor 2 decreases.

As an alternatively or complementary way to change the angle of the major rotor axis A_r relative the direction of the fluid flow F_d, the minor rotors 6 can be run in reverse to control the rotational speed of the major rotor 2. In addition to generating power from the rotation of the minor rotors 6, the minor rotors 6 can be used as motors to reduce the rotational speed of the major rotor 2 in case of a too high rotational speed of the major rotor 2. The opposite is also possible, i.e. to use the minor rotors 6 to increase the rotational speed of the major rotor 2. This can be useful during start-up of operation of the submersible power plant 1.

In the example shown in FIG. 1, the major rotor blades 4 exhibits a decreasing span and thickness towards each major rotor blade end 4a.

As an alternatively or complementary way to change the angle of the major rotor axis A_r relative the direction of the fluid flow F_d, the major rotor blades 4 comprises control surfaces 10. In the example of FIG. 1, the control surfaces 10 are flaps but also ailerons are conceivable. The control surfaces 10 of each major rotor blade 4 may be individually controllable for increased control of the angle of the major rotor axis A_r relative the direction of the fluid flow F_d.

In the example shown in FIG. 1, the major rotor 2 comprises stop flaps 11. If present on the major rotor blades 4, these can be used to bring the rotational speed of the major rotor 2 down to essentially zero by being deployed. Deploying these will increase the drag on the major rotor 2, thereby reducing the rotational speed. They can also be used to maintain the rotational speed at zero when the submersible plant is in stop mode.

The buoyant body 3 comprises a motor, in the example shown an electrically driven swivel 12 arranged to untwist the tether 8 by rotating the buoyant body 3 relative the major rotor 2. This is done when the rotational speed of the major rotor 2 is essentially zero.

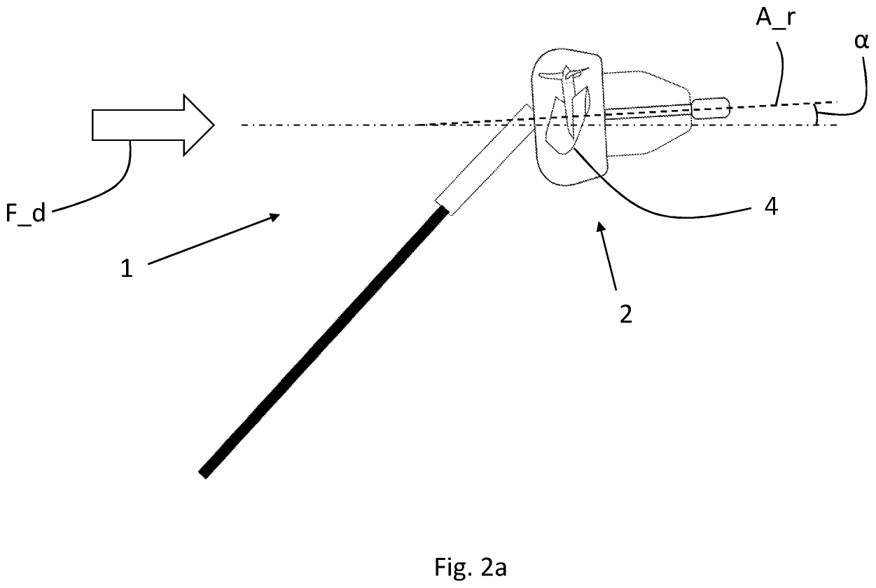

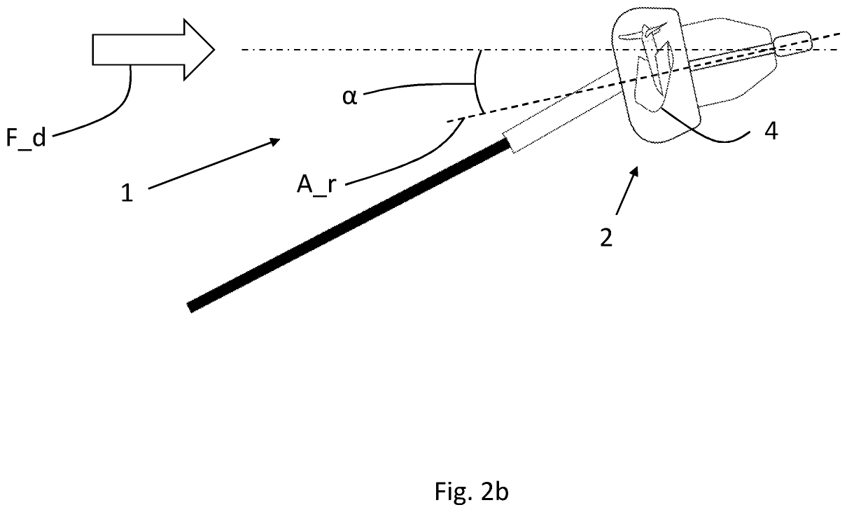

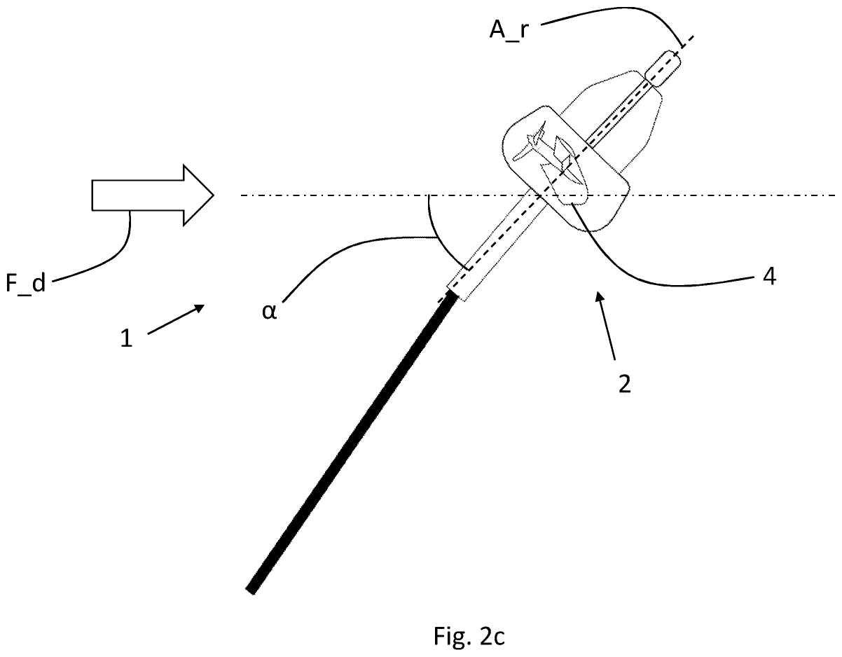

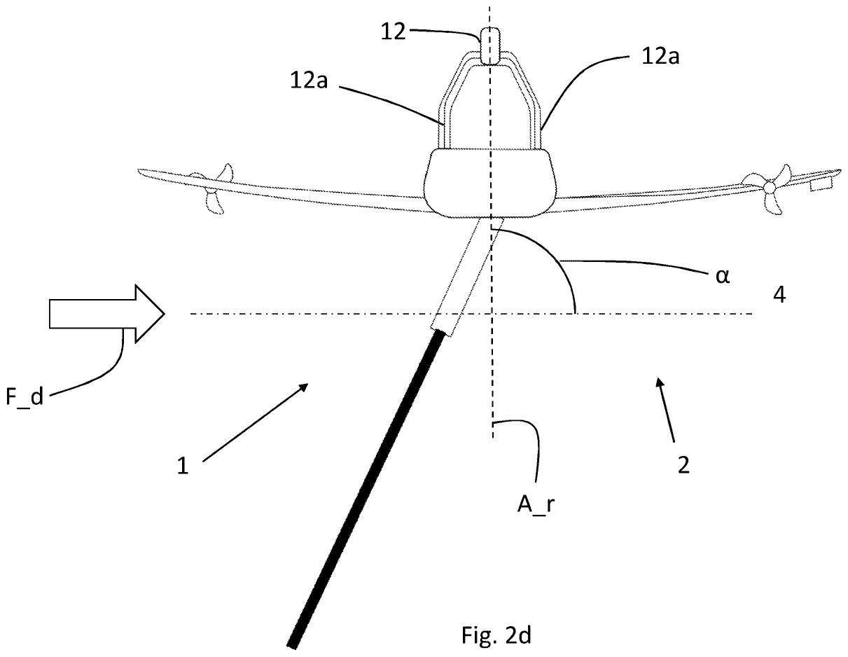

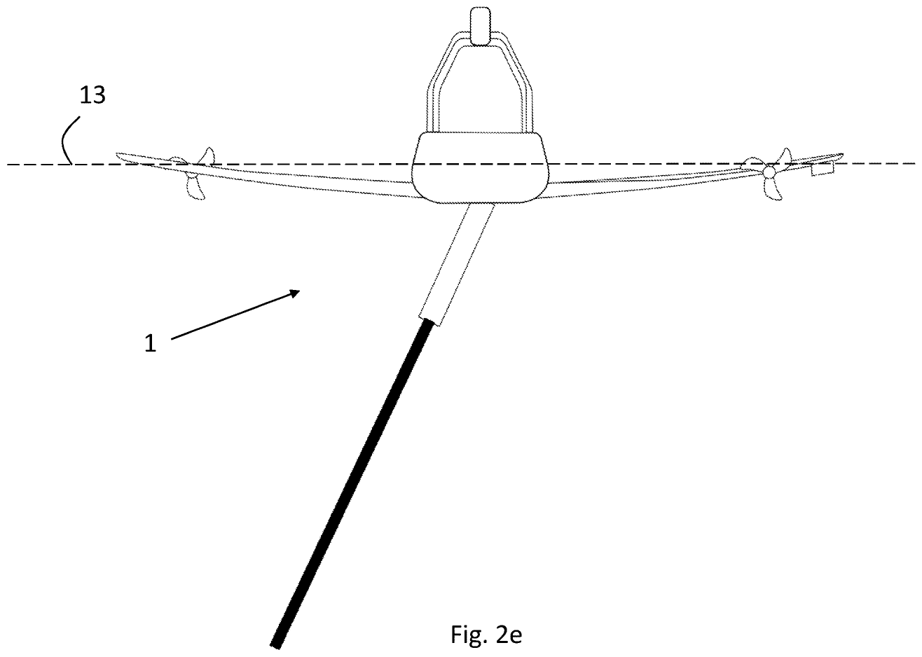

FIGS. 2a-2e shows the submersible plant with different angles of the major rotor axis A_r relative the direction of the fluid flow F_d. In FIGS. 2a-2d, the fluid flow, e.g. tidal stream or ocean current, is flowing from left to right in the figures.

In FIG. 2a, the submersible power plant 1 is close to or at max production. In this state, the angle α of the major rotor axis A_r relative the direction of the fluid flow F_d is small such that the rotational speed of the major rotor 2 is high leading to a large production of power by the submersible power plant 1.

In FIG. 2b, the submersible power plant 1 has begun to pitch to increase the angle α of the major rotor axis A_r relative the direction of the fluid flow F_d using one or more of the ways described in conjunction with FIG. 1. In this way, the velocity of the major rotor 2 decreases as the lift of the major rotor blades 4 decreases. This may be necessary if the submersible power plant 1 comes to close to the seafloor or if the rotational speed of the major rotor 2 approaches or exceeds its maximum design speed.

In FIG. 2c, the submersible power plant 1 has initiated stop mode to bring the rotational speed of the major rotor 2 down to zero by further increasing the angle α of the major rotor axis A_r relative the direction of the fluid flow F_d. In the example of FIG. 2c, stop flaps 11 on the major rotor blades 4 assist in bringing the rotational speed of the major rotor 2 down to zero. Other ways as described in conjunction with FIG. 1 can also be used.

In FIG. 2d, the submersible power plant 1 has entered stop mode. In this mode, the rotational speed is essentially zero and the submersible power plant 1 lie still in the water. In this mode, the angle α of the major rotor axis A_r relative the direction of the fluid flow F_d is essentially 90°. In this mode, it is possible for the electrically driven swivel 12 arranged to untwist the tether 8 by rotating the buoyant body 3 relative the major rotor 2 if necessary as the major rotor 2 is stationary. The electrically driven swivel 12 is powered by the electric cables of the tether 8 running through the buoyant body 3. The electrically driven swivel 12 is connected to the major rotor by swivel arms 12a.

In FIG. 2e, while still in stop mode, it is also possible to move the submersible power plant 1 to the surface 13 for maintenance and repairs.

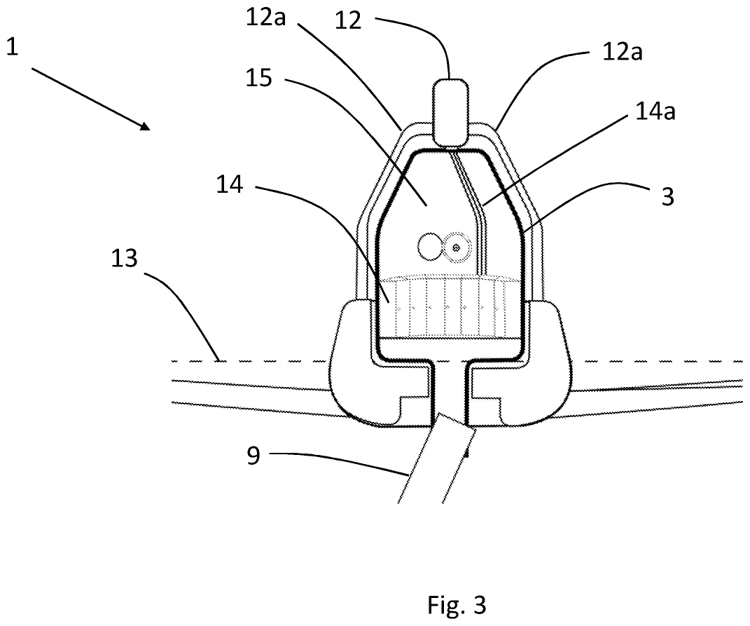

FIG. 3 schematically shows a cross sectional view of the buoyant body 3 of the submersible power plant 1 of the invention. In FIG. 3, the submersible power plant 1 is shown in stop mode at the surface 13. The buoyant body 3 comprises a power electronics compartment 14 comprising the power electronics required for the operation of submersible power plant 1 and at least one ballast tank 15 that is used to regulate the buoyancy of the buoyant body 3 by emptying and filling the ballast tank 15. The emptying and filling of the ballast tank 15 is made by known means.

As previously mentioned, during operation of the power plant 1, the buoyant body 3, the tether 8 and the arm 9 does not rotate relative the major rotor 2. Thus, when the major rotor 2 is stationary, it is possible to rotate the buoyant body 3, the tether 8 and the arm 9 to untwist the tether 8 if necessary. Power cables 14a running through the buoyant body 3 power the electrically driven swivel 12.

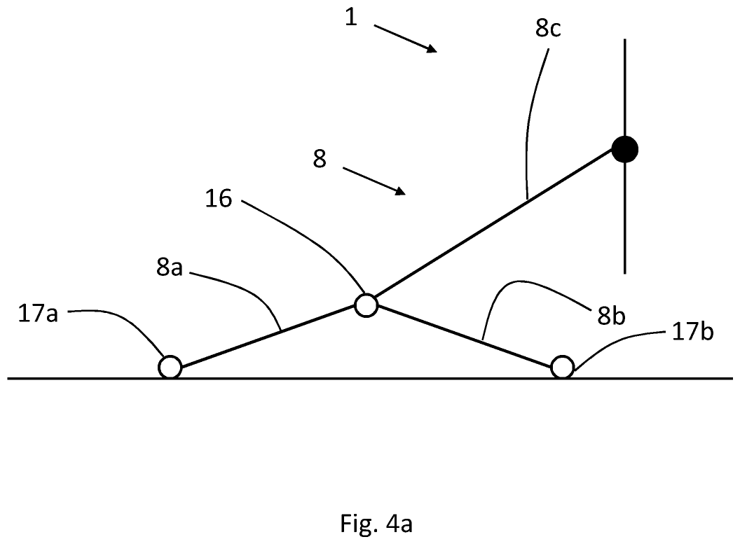

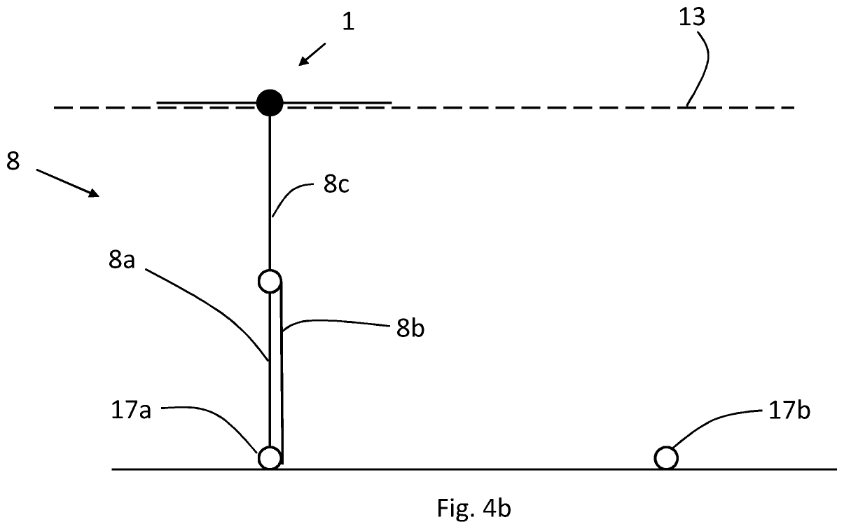

FIGS. 4a and 4b schematically show a two-part tether 8 anchoring according to an example embodiment of the invention. Sizes of the individual parts are not to scale. In FIG. 4a, the submersible power plant 1 is attached with a tether 8 that comprises a tether connection 16 from which a first tether part 8a attaches to a first structure 17a and a second tether part 8b attaches to a second structure 17b. Further, a main tether part 8c attaches the submersible power plant 1 to the tether connection 16. This is an alternative to using a tether 8 that only attaches to one structure. By using a tether 8 according to the example of FIG. 4, it is possible to release one of the first or second tether parts 8a, 8b to bring the submersible power plant 1 to the surface 13. The released tether part can after maintenance or repairs be brought down to the seafloor and reattached to its structure to prepare the submersible power plant 1 for operation again.

In FIG. 4b, the second tether part 8b of the tether 8 has been disconnected from the second structure 17b. The submersible power plant 1 is in stop mode and is brought to the surface 13 for maintenance or repairs. The second tether part 8b hangs freely and can be reattached to the second structure 17b, for instance by means of a submersible remotely operated vehicle (ROV).

The submersible power plant 1 has as one of its advantages that it is safe to operate since seafloor avoidance relies on buoyancy. Further, the vertical tether force component is balanced with the buoyancy of the buoyant body 3, which makes the output indifferent to where in the water column it operates.

Reference signs mentioned in the claims should not be seen as limiting the extent of the matter protected by the claims, and their sole function is to make claims easier to understand.

As will be realised, the invention is capable of modification in various obvious respects, all without departing from the scope of the appended claims. Accordingly, the drawings and the description are to be regarded as illustrative in nature, and not restrictive.

1. A submersible power plant comprising: a major rotor arranged on a buoyant body relative which the major rotor can rotate, wherein the major rotor comprises at least two major rotor blades and is rotatable around a major rotor axis from a fluid flow acting on the major rotor blades, wherein the major rotor comprises a minor rotor connected to a minor generator arranged on each major rotor blade, wherein each minor rotor comprises a minor rotor blade rotatable around a minor rotor axis from the rotation of the major rotor, wherein each minor rotor axis is substantially perpendicular to the major rotor axis and to an extension of the major rotor blades from the major rotor axis to each major rotor blade end, wherein the buoyant body of the submersible power plant is arranged to be secured to a structure by a tether, wherein the submersible power plant is arranged to change an angle of the major rotor axis relative to a direction of the fluid flow, thereby controlling the rotational speed of the major rotor, wherein the submersible power plant comprises an arm connected to the tether and the buoyant body, wherein the arm is rotatably connected to the buoyant body and is arranged to change the angle of the major rotor axis relative the direction of the fluid flow by rotating the arm relative to the buoyant body by changing an angle of a rotatable attachment of the arm relative the buoyant body.

2. (canceled)

3. The submersible power plant according to claim 1, wherein the arm is buoyant.

4. The submersible power plant according to claim 1, wherein the major rotor blades are flexible.

5. The submersible power plant according to claim 1, wherein a span and thickness of the major rotor blades decrease towards an end of the major rotor blades.

6. The submersible power plant according to claim 1, wherein the major rotor blades comprise control surfaces.

7. The submersible power plant according to claim 6, wherein the control surfaces of each major rotor blade are individually controllable.

8. The submersible power plant according to claim 1, wherein the buoyant body comprises at least one ballast tank.

9. The submersible power plant according to claim 1, wherein the minor rotors can be run in reverse to control the rotational speed of the major rotor.

10. The submersible power plant according to claim 1, wherein the angle of the major rotor axis relative the direction of the fluid flow can be changed such that the rotational speed of the major rotor is essentially zero.

11. The submersible power plant according to claim 9, wherein the major rotor comprises stop flaps.

12. The submersible power plant according to claim 9, wherein the buoyant body comprises a motor arranged to untwist the tether by rotating the buoyant body relative the major rotor when the rotational speed of the major rotor is essentially zero.

13. The submersible power plant according to claim 1, wherein the buoyant body comprises power electronics.

14. The submersible power plant (1) according to claim 1, wherein the tether is divided into two parts each arranged to be removably connected to a structure.

15. The submersible power plant according to claim 1, wherein the major rotor is mechanically connected to a major generator inside the buoyant body such that electrical power is generated by the rotation of the major generator by the major rotor.

16. The submersible power plant according to claim 1, wherein the tether comprises electrical cables and signal cables for routing electrical power generated by the generators to an onshore substation.
